(19) United States
(12) Patent Application Publication
(10) Pub. No.: US 2019/0373887 A1
(43) Pub. Date: Dec. 12, 2019

(54) ENCAPSULATED MOLUSCICIDE

(71) Applicant: INGWERMAT LIMITED, ILKLEY (GB)

(72) Inventor: GEOFFREY WHITELEY, ILKLEY (GB)

(21) Appl. No.: 15/777,585

(22) PCT Filed: Nov. 25, 2016
(86) PCT No.: PCT/EP2016/078914

§ 371 Date: May 18, 2018

(30) Foreign Application Priority Data
Dec. 1, 2015 (GB) 1521180.8

(51) Int. Cl. A01N 35/02; A01N 25/28

(52) U.S. Cl. CPC A01N 35/02; A01N 25/28

(57) ABSTRACT

A molluscicidal dosage form is provided and includes one or more microcapsule shells containing a fill, the shell including a water insoluble material which is digestible by a mollusc and the fill including an aldehyde selected from the group consisting of aldehydes of formula R—CHO wherein R is a saturated C₃-C₁₂ alkyl or mixtures thereof.

### BACKGROUND

### Field of Invention

This invention relates to a molluscicide formulation, particularly but not exclusively for use in outdoor horticultural or agricultural applications.

### Description of Related Art

Slugs and snails have been controlled by application of ingestible mollusc baits. Slug pellets are designed to be spread around plants in outdoor environments which are exposed to rainfall to reduce damage to garden plants and agricultural crops from grazing slugs and snails.

Metaldehyde is a leading active agent for the control of slugs and snails in crops and specifically targets molluscs. It has been used extensively around the world for many decades in agriculture and horticulture. Slugs and snails can pose significant problems in agricultural crops and gardens and the most common method of using metaldehyde for their control is by incorporating between 1% and 5% of powdered metaldehyde into ingestible molluscicide baits made of materials like wheat flour and bran. Pellets of these types have been found to be very effective at controlling slug and snail pests but some problems have arisen from their widespread use.

A first problem which is addressed by the current invention is to provide an alternative that can in part or wholly substitute for metaldehyde as an active agent in slug pellets to reduce metaldehyde use in areas where there is a risk of contamination of groundwater or surface water supplies with residual traces of metaldehyde.

A second problem which is addressed by the current invention is to provide an alternative that can be in part or wholly substitute for metaldehyde as an active agent in slug pellets to reduce the risk of acute toxicity if ingested accidentally by children and non-target species such as birds, domestic pets and farm animals.

The first problem has arisen in the UK where metaldehyde has been found in run-off from agricultural fields with traces persisting into surface water and ground water supplies that are used for drinking water. It has been reported since 2007 that the presence of trace levels of metaldehyde derived for the use of metaldehyde to control slugs in agricultural crops has been detected in drinking water supplies. This is a problem because current drinking water treatment methods are not effective at reducing the levels of metaldehyde in water. (Water UK Briefing Paper, 31 Oct. 2012). The problem is well known to suppliers of metaldehyde based slug pellets in the UK where the water industry is working with the producers and distributors of metaldehyde (Metaldehyde Stewardship Group, www.getpelletwise.co.uk) on mitigation measures. It is possible that further restrictions may be introduced on application rates of metaldehyde slug pellets, the crops on to which they can be applied and the time of year when they can be applied. Exceedances have to be avoided for water companies to meet their obligations under the Water Framework Directive (WFD) without resorting to diversion or switching off water supplies.

Metaldehyde is generally considered safe when used as directed. The World Health Organisation (WHO) classifies metaldehyde as a class II ‘moderately hazardous’ pesticide (CDS Tomlin, The Pesticide Manual, British Crop Protection Council, 1997, p 606). Metaldehyde is not known to cause harm to beneficial organisms such as earthworms, bees or slug-eating ground beetles. It also has low toxicity to other water and soil organisms. However, accidental cases of acute toxicity are reported from time to time and there is a demand for alternatives which have comparable efficacy but reduced risk of acute toxicity in non-target animals arising from accidental ingestion.

Metaldehyde has a number of properties which favour its widespread use as a molluscicide. As a colourless, sparingly soluble and odourless solid it is can be readily incorporated into edible bait as a powdered ingredient. The mode of action of metaldehyde on the target mollusc has been studied in detail (as described below) and has been shown to involve multiple effects on tissues and organs which vary over time of exposure, dose rate and various physiological and environmental conditions. In research into the mode of action of metaldehyde, acetaldehyde has been shown to reproduce some of the effects of metaldehyde and it may also be partially responsible for the observed toxic effects of metaldehyde following hydrolysis to acetaldehyde in the mollusc gut (Effects of metaldehyde and acetaldehyde on specific membrane currents in neurones of the pond snail Lymnaea stagnalis. Mills et al., Pesticide Science Volume 34, pages 243-247, 1992). Acetaldehyde would be unsuitable for use as a substitute for metaldehyde because it is a highly volatile liquid which cannot be contained in pelleted bait and detection of the pungent vapour would prevent ingestion by feeding molluscs.

The symptoms of poisoning after ingestion of metaldehyde or in the presence of acetaldehyde are similar (Trieskorn et al. Effects of orally applied metaldehyde on mucus cells of slugs (Deroceras reticulatum) depending on temperature and duration of exposure.). There is an increase in mucus secretion which can lead to desiccation of the whole animal and structural damage to mucus secreting cells on prolonged exposure. Animals show muscular spasms, undirected mouthing movements and uncoordinated locomotion. This is followed by a period of immobility. The isolated central nervous system of L. stagnalis has been used to study the effects of metaldehyde and acetaldehyde on the neural activity underlying feeding and demonstrate a specific receptor response (Mills et al. Effects of metaldehyde and acetaldehyde on feeding responses and neuronal activity in the snail, Lymnaea stagnalis. Pesticide Science Volume 28, Issue 1, pages 89-99, 1990.). Application of metaldehyde or acetaldehyde can induce a similar increase in firing activity and development of paroxysmal depolarising shifts in buccal motor neurons. It is argued that this type of activity could explain some of the symptoms of poisoning seen in the whole animal after ingestion of metaldehyde, and that acetaldehyde may be responsible for some of the toxic effects of metaldehyde.

### DETAILED DESCRIPTION

According to the present invention, a molluscicidal dosage form comprises one or more microcapsule shells containing a fill;

the shell comprising a water insoluble material which is digestible by a mollusc;

the fill comprising an aldehyde selected from the group consisting of aldehydes of formula R—CHO wherein R is a saturated C₃-C₁₂ alkyl or mixtures thereof.

Preferably R is saturated linear C₃-C₁₂ alkyl. More preferably R is saturated linear C₇ to C₉ alkyl.

Particularly advantageous aldehydes are selected from the group consisting of: 1-heptanal, 1-octanal, 1-nonanal, 1-decanal and mixtures thereof. Preferred are 1-heptanal, 1-octanal, 1-nonanal and mixtures thereof.

Preferably R is unbranched.

The invention further provides a dosage form which includes metaldehyde either in the fill or externally of the fill. The invention therefore provides a molluscicidal dosage form in which metaldehyde is partially replaced.

Preferably no metaldehyde is present.

The fill may further comprise one or more excipients. Suitable excipients include alcohols, carboxylic acids and esters having alkyl chains selected from the group R, preferably having the same alkyl group as the aldehyde component. These excipients may enhance the potency of the composition.

The microcapsule shell may be composed of a solid matrix material comprising lipid, modified starches and proteins. The capsule shell may be composed of any of the materials commonly used for formation of microcapsules.

The microcapsules may be made by physical methods, physico-chemical methods or by chemical methods known to those skilled in the art. Physical methods include centrifugal extrusion or core-shell encapsulation using a vibrational nozzle. Chemical methods may include interfacial polycondensation.

Preferred shell materials may be selected from the group consisting of: beeswax, starch, gelatine, polyacrylic acid, polyphosphate, alginate, chitosan, carrageenan, starch, modified starch, oligofructans, konjak, alpha-lactalbumin, beta-lactoglobumin, ovalbumin, poly(ethylene glycol) sorbitol hexaoleate, maltodextrin, cyclodextrin, cellulose, cellulose ether, methylcellulose, ethylcellulose, hydropropylmethylcellulose, carboxymethylcellulose, hydroxypropyl cellulose, milk protein, canola protein, albumin, chitin, polylactides, poly(lactide-co-glycolide) derivatized chitin oligosaccharides, polylysine, diutan gum, locust bean gum, welan gum, xanthan gum. The shell materials may also include a flavour, a nutrient, or a drug.

The size of the microcapsules can be adjusted between less than 0.1 micron to greater than 1000 microns to permit 10 to 5 of the microcapsules to be incorporated into a 1 mm diameter by 2 mm length pellet.

In a preferred embodiment, the shell comprises a microbial cell body, preferably a yeast.

A wide range of microbial microcapsules such as algae, bacteria and fungi may be employed due to the presence of a protective polymeric envelope or cell wall. Preferably the microcapsules are provided by fungal cells which may be derived from one or more fungi from the groups comprising Zygomycota, Glomeromycota. Ascomycota, Basidiomycota and Chytridiomycota. More preferably, the fungal cell is derived from yeasts. The most preferred fungi are Saccharomycetes, e.g. Saccharomyces cerevisiae, Saccharomyces boulardii, Torula yeast (Candida utilis) but Schizosaccharomycetes. e.g. Schizosaccharomyces pombe may be employed.

The microbial microcapsules may most conveniently be provided by bakers yeast, brewers yeast or yeast available as a by-product of ethanol biofuel production using Saccharomyces cerevisiae.

The method of the invention may be carried out with “live” microbial microcapsules but more preferably for convenience they are inactive or non-viable to improve ease of handling during processing.

A coating may be applied to the one or more microcapsule shells comprising, for example, starch. Such a coating may improve handling and prevent aggregation during storage.

The coating may be a farinaceous material. For example, suitable coatings may be selected from the group consisting of: starch, pectin, agar, gelatine, guar gum, gum arabinose, cellulose, polysaccharides (starches, vegetable gums), proteins.

Alternative coating materials comprise: non-food carriers, for example: cellulose complexes, sand, clay, silica, polyacrylic acid polymers, polyacrylimide acid polymers, diatomaceous earth, aliginate and wax.

Preferred starches may be selected from the group consisting of: arrowroot, corn starch, potato starch, sago, tapioca or modified and derivative starches.

Vegetable gums, for example guar gum, locust bean gum and xanthan gum, may be used in the coating as a binder. Proteins may be used. These may be selected from collagen, egg white, furcellaran and gelatine. Carbohydrates including sugars may also be employed.

The following substances may be included in the coating materials to enhance palatability;

vitamin B, in particular BI, B2, nicotinic acid or nicotinamide;

vitamin E;

animal or vegetable proteinaceous material, albumins and hydrolytic degradation products thereof, pepsin, metaproteins, proteoses, peptones, polypeptides, peptides, diketopiperazines and amino acids;

amino acids or salts or amides thereof;

nucleic acids or hydrolytic degradation products, nucleotides, nucleosides, adenine, guanine;

cytosine, uracil or thymine;

urea or carbamic acid;

an ammonium salt, for example ammonium acetate;

an amino sugar, for example glucosamine or galactosamine.

phagostimulants may be used to enhance ingestion and attraction.

Preservatives, taste-altering additives, water-proofing agents, antioxidants, suspending agents, UV stabilizers, odour masking agents and anti-microbial agents may also be employed.

Suitable preservatives may include Legend MK®, available from Rohn & Haas Company of Philadelphia, Pa. and CA-24, available from Dr. Lehmann and Co. of Memmingen/Allgau, Germany. Preservatives can be mixed with water to form a stock solution to be added to the formulation at a concentration in the range of about 10-750 ppm.

Waterproofing agents, which can also act as binders, can be added to the composition to improve the weatherability of the composition. These are typically water insoluble compounds such as waxy materials and other hydrocarbons. Examples of suitable waterproofing agents include paraffin wax, stearate salts, beeswax or other hydrophobic compounds.

The invention provides several advantages.

Microcapsules in accordance with the present invention have the advantage that the aldehyde fill is not released upon exposure to an aqueous environment.

The present invention allows manufacture of slug pellets containing the capsulated aliphatic aldehyde composition as an active ingredient for use on areas of land, upon crops and at times of year when use of metaldehyde is either restricted in amount or prohibited. The composition of the present invention may be used as a substitute or partial replacement for metaldehyde because the aliphatic aldehydes of this invention are less persistent in water supplies. As a partial replacement the present invention will act to overload the common carboxylase decomposition and detoxification pathway of aldehydes in cellular metabolism so that when included in bait with metaldehyde as a co-additive aldehyde enhances the toxic effect produced from a reduced dose of metaldehyde.

The present invention allows manufacture of slug pellets containing the encapsulated aliphatic aldehyde composition as the entire active agent or in combination with metaldehyde as a partial substitute for metaldehyde in slug pellets. Compositions of the present invention have a lower acute toxicity threshold for mammals.

The present invention provides a molluscicidal composition containing an aldehyde other than metaldehyde encapsulated in a robust impermeable microcapsule sufficient to prevent leakage or loss of the aldehyde by leaching or volatilisation when microcapsules are incorporated at an effective dose rate in slug pellets. The encapsulation process and composition of the encapsulating shell material is selected from the range of encapsulation technologies available in the industry for encapsulating liquid and volatile ingredients whilst being insoluble in water but readily degradable by digestive enzymes.

The amount of the aldehyde per microcapsule may be selected so that the dosage after ingestion may be from 20 to 1000 μg/slug. Alternatively or in addition the dosage may be preferably from 40 to 800 μg/pellet, more preferably from 60 to 400 μg/pellet. The pellets may be manufactured by extrusion. The microcapsules and excipients may be mixed with water to form a dough which is extruded to form a ribbon, followed by drying of the ribbon and cutting into pellets. Alternatively, the ribbon may be cut into pellets before drying.

The excipients typically may include wheat flour, a dye and a preservative.

The dried pellets may have an average length of 1 to 4 mm, preferably 1.5 to 3 mm.

Table 1 shows commonly reported LD50 values of acute oral toxicity in rats for a group of aliphatic straight chain aldehydes compared to acetaldehyde, metaldehyde and paraldehyde.

TABLE 1
LD50 values of acute oral toxicity in rats for
a group of aliphatic straight chain aldehydes

| | |
|---|---|
| 1-heptanal | LD50 > 5000 mg/kg |
| 1-octanal | LD 50 4616 mg/kg |
| 1-nonanal | LD 50 > 5000 mg/kg |
| 1-decanal | LD 50 3096 mg/kg |
| Acetaldehyde | LD50 661 mg/kg |
| Metaldehyde | LD50 630 mg/kg |
| Paraldehyde | LD 50 2711 mg/kg |

The oral toxicity of metaldehyde and acetaldehyde are similar. There is no benefit in using encapsulated acetaldehyde as a substitute for metaldehyde. The longer chain aliphatic aldehydes of this invention have lower oral toxicity and may also have other chemical and physical properties amenable to encapsulation (Table 4).

### Example 1—Comparative Toxicity

To investigate relative toxicity of aldehydes to molluscs, tests were conducted using a method adapted from Adriaens et al. The Mucosal Toxicity of Different Benzalkonium Chloride Analogues Evaluated with an Alternative Test. Pharmaceutical Research, Vol. 18, pages 937-941, 2001.

Common garden slugs (Arion distinctus) weighing between 1.9 g and 5.2 g were collected from a UK suburban garden and placed into vented plastic boxes lined with paper towels moistened with phosphate buffered saline. The boxes were kept in the shade inside a greenhouse (10° C. minimum) and fed with lettuce and commercial dog food. Experiments were conducted on six slugs for each test treatment using petri dishes containing Whitman Grade 1 general purpose filter papers (90 mm diameter). Filter papers were wetted to saturation with phosphate buffered saline (pH 7.4) and allowed to drain before placing in the petri dishes. At the beginning of each test slugs were placed individually in a petri dish which had been prepared 3 hours previously as a control or with 60 mg of the test substance consisting of fine powdered metaldehyde or a liquid aldehyde. After 30-min incubation slugs were removed and returned to petri dishes with filter papers wetted only with the phosphate buffered saline. The slugs were weighed separately before and after treatment. The change in weight caused by the treatment was calculated and expressed as % (w/w) of the body weight. The petri dishes containing the test medium were also weighed before and after the treatment. The weight of mucus produced was calculated and expressed as % (w/w) of the body weight. The treatment and measurements were repeated 24 hour later and final weights taken after a second 24 hour period.

TABLE 2
Amounts of mucus produced by slugs during 30-min incubation
contact period expressed as percentage of the body weight (means
and S.D.s for n = 6) after initial treatment and second
treatment 24 hours later. Apparent potency relative to metaldehyde
was estimated from the percentage reduction in mucus release
using combined losses of mucus for the two tests on each slug
in the test solution relative to metaldehyde.

| | Metal- | 1- | 1- | 1- | Con- |
|---|---|---|---|---|---|
| | dehyde | heptanal | octanal | decanal | trol |
| Mucus loss initial | 5.55 | 2.77 | 3.82 | 3.28 | −0.97 |
| test (% wt % w/w) | | | | | |
| SD | 1.57 | 1.12 | 1.23 | 0.97 | 0.31 |
| wt % Mucus loss 24 | 3.94 | 0.55 | 2.98 | 2.64 | −1.93 |
| test (% wt % w/w) | | | | | |
| SD | 1.11 | 0.22 | 0.96 | 0.78 | 0.63 |
| wt % Combined | 9.49 | 3.32 | 6.8 | 5.92 | — |
| mucus loss (% w/w) | | | | | |
| Potency - loss of | 100 | 35 | 72 | 62 | — |
| mucus relative to | | | | | |
| metaldehyde (%) | | | | | |

TABLE 3
Reduction in body weight at 24 h and 48 h after initial
treatment (means and S.D.s for n = 6) as a percentage
of the initial body weight. Apparent potency relative to
metaldehyde was estimated as the percentage reduction in
body weight after 48 hours relative to metaldehyde.

| | Metal- | 1- | 1- | 1- | Con- |
|---|---|---|---|---|---|
| | dehyde | heptanal | octanal | decanal | trol |
| Reduction in body | 68.5 | 85.2 | 78.6 | 79.7 | 92 |
| weight after 24 h | | | | | |
| (wt %) | | | | | |
| SD | 6.79 | 11.86 | 12.2 | 11.05 | 4.4 |
| Reduction in body | 55.4 | 76.5 | 68.7 | 74.1 | 86.8 |
| weight after 48 h | | | | | |
| (wt %) | | | | | |
| SD | 5.49 | 10.65 | 10.63 | 10.28 | 4.16 |
| Potency - loss of | 100 | 33 | 58 | 40 | 0 |
| body weight relative | | | | | |
| to metaldehyde (%) | | | | | |
| after deduction of | | | | | |
| weight loss from | | | | | |
| the control | | | | | |

TABLE 4
Physical properties of C2 to C10 aldehydes: octanol-water partition coefficient, molecular mass,
vapour pressure, water solubility, boiling point (BP) with projected relative potency as a molluscicide
(relative response rate) and effective dose rate multiplier based simply on weighted mass ratios and
assumed equivalence per aldehyde terminal group.

| | | Log | | | | | | | | | |
|---|---|---|---|---|---|---|---|---|---|---|---|
| | | Octanol- | | | Water | | | | | | |
| | | Water | | VP mm | solubility | | | | | | |
| | | Partition | | Hg at 25 | mg/l at | | Response | Dose | Aldehyde | Mass | |
| | | Coef | Mass | deg C. | 25 C. | BP C. | rate | rate | groups | ratio | Weighted |
| C3 | Paraldehyde | 0.7 | 132.16 | 15.7 | 24140 | 124.3 | 1.00 | 1.00 | 3 | 0.75 | 0.25 |
| Para | | | | | | | | | | | |
| C4 | Metaldehyde | 0.85 | 176.21 | 0.000674 | 222 | 246 | 1.00 | 1.00 | 4 | 1.00 | 0.25 |
| Meta | | | | | | (MP) | | | | | |

Straight chain monomers

| | | | | | | | | | | | |
|---|---|---|---|---|---|---|---|---|---|---|---|
| C2 | Ethanal | −0.17 | 44.05 | 902 | 256000 | 20.1 | 1.00 | 1.00 | 1 | 0.25 | 0.25 |
| C3 | Propanal | 0.33 | 58.08 | 317 | 42990 | 48 | 0.76 | 1.32 | 1 | 0.33 | 0.33 |
| C4 | Butanal | 0.82 | 72.11 | 108 | 23800 | 74.8 | 0.61 | 1.64 | 1 | 0.41 | 0.41 |
| C5 | Pentanal | 1.31 | 86.13 | 32.9 | 9718 | 103 | 0.51 | 1.96 | 1 | 0.49 | 0.49 |
| C6 | Hexanal | 1.8 | 100.16 | 9.57 | 3527 | 131 | 0.44 | 2.27 | 1 | 0.57 | 0.57 |
| C7 | Heptanal | 2.29 | 114.19 | 3.52 | 1167 | 152.8 | 0.39 | 2.59 | 1 | 0.65 | 0.65 |
| C8 | Octanal | 2.78 | 128.21 | 1.49 | 394.3 | 171 | 0.34 | 2.91 | 1 | 0.73 | 0.73 |
| C9 | Nonanal | 3.27 | 142.24 | 0.564 | 131.6 | 191 | 0.31 | 3.23 | 1 | 0.81 | 0.81 |
| C10 | Decanal | 3.76 | 156.15 | 0.235 | 43.52 | 208.5 | 0.28 | 3.54 | 1 | 0.89 | 0.89 |

It was found (Tables 2 and 3) that C₇ to C₁₀ aldehydes show higher than expected toxicity as metaldehyde substitutes when placed in contact with the mucus membrane of molluscs. Whereas the oral toxicity values of heptanal, octanal and decanal in rats are lower by approximately 8 fold relative to metaldehyde on a weight for weight basis (Table 1), the mollusc foot contact tests (Tables 2 and 3) show less than single fold reductions. Measured potency was also higher than estimates of relative potency calculated from the weighted mass ratios assuming equivalence per aldehyde terminal group (Table 4). Similar ranges of elevated potency were observed when comparing both mucus loss during the short test periods and total loss of body weight over the 48 hour testing period (Table 5).

TABLE 5
Summary of potency relative to metaldehyde
(weight for weight basis)

| | Reduction in toxic response relative to metaldehyde | | | |
|---|---|---|---|---|
| | Simple weight | | | |
| | for weight | | Loss of | Rat |
| | equivalence | Loss of mucus | body weight | Oral LD50 |
| | (Table 4) | (Table 2) | (Table 3) | (Table 1) |
| 1-heptanal | 0.39 | 0.35 | 0.35 | 0.13 |
| 1-octanal | 0.31 | 0.72 | 0.58 | 0.14 |
| 1-decanal | 0.28 | 0.62 | 0.40 | 0.13 |

Without wishing to be bound by theory, it is possible that higher than expected toxicity, particularly in the mucus loss test can be attributed to the differences in lipophilic properties of the alkyl chains attached to the aldehyde terminal group. In particular, large increases in Log P relative to metaldehyde (Table 4) may enhance adherence to and penetration into cell. This may reduce the ability of the toxin to be flushed by the mucus released in response. In addition, the higher water solubility of 1-heptanal and 1-octanal compared to metaldehyde (Table 4) may cause increased exposure of the mucus membrane to the toxin during the short-term contact periods.

Preferably the aldehyde is selected from the group consisting of of 1-hepatanal, 1-octanal, 1-nonanal, and mixtures thereof. Straight chain heptanal, octanal, nonanal may be assigned to the same chemical category for the purposes of safety and human exposure, because of their close structural relationships and their similar physio-chemical properties. The three aldehydes are readily oxidized to their corresponding carboxylic acids in vivo. These carboxylic acids are endogenous in animals which are formed and broken down in the fatty acid pathway. This group this chemical category is currently recognized by the U.S. Food and Drug Administration (FDA) as GRAS (“generally regarded as safe”) for as flavouring substances in food additives as well as being common naturally occurring components of many foods. Persistence in the environment is considered to be short (150 to 235 hours) which is consistent with the ready biodegradability of the substances. (The Flavour and Fragrance High Production Volume, Consortia. Publication Ref 201-15464A. The C&9 Consortium FFHPVC C&9 Aliphatic Aldehydes and Carboxylic Acids, submitted to the EPA under the HPV Challenge Program by: The Flavour and Fragrance High Production Volume Chemical Consortia, 1620 I Street, NW, Suite 925, Washington, D.C. 20006).

### Example 2 Encapsulation Method

Incorporation of the aldehydes of this invention into microcapsules can be achieved using a solid matrix made from lipids, modified starches and proteins. Any of these materials can form enzyme degradable coatings for applications such as oral drugs for release in the digestive system. Encapsulation is a common method for preparing active ingredients for incorporation into foods, medicines and agrochemicals and liquid aldehydes have been incorporated in this form as flavour components in food and fragrance components in cosmetics. (WO94/06308 Flavour Encapsulation.) and (Flavour encapsulation and controlled release-a review, A Madene, M Jacquot, J Scher, S Desobry—International journal of food science, 2006.) The group of 1-heptanal, 1-octanal, 1-nonanal are small polar organic molecules with Log P values (Table 4) between 2.29 and 3.27 and are particularly amenable to direct encapsulation in microbial cell bodies such as yeast.

Test material was prepared using a method similar to that described in EP2214654 A2, Method of encapsulation, the disclosure of which is incorporated into this specification by reference for all purposes.

Step (a) Air dried baker's yeast (Saccharomyces cerevisiae) was imbibed with 1-octanal in an anhydrous moisture-free environment for 12 hours at 45° C. while stirring. Step (b) at the end of step (a) the yeast microcapsules were separated from the octanal and exposed gradually to an aqueous environment. The microcapsules from step (a) were treated with an initial octanal and water mixture and then, using successive aliquots of water, a mixture of octanal and water containing increasing amounts of water relative to octanal, until the yeast was washed with water only.

After washing, the yeast microcapsules were dried by spray drying and coated with starch to improve handling and prevent aggregation. Once encapsulated, the octanal was not released by exposure of the yeast microcapsules to an aqueous environment, for example, when incorporated into slug bait for outdoor field use and rainfall. A resultant encapsulate was produced containing 29% n-octanal (w/w) as a fine dry flowing powder suitable for incorporation into slug pellets. Estimates of incorporation rates in slug pellets and field application rates as a metaldehyde substitute are given in Table 6, based body weight loss comparator from Table 5.

The present invention further provides an aldehyde other than metaldehyde encapsulated through imbibition into intact microbial cells such that the encapsulated aldehyde is not released on exposure to water and forming robust impermeable microcapsules that will release the aldehyde to act as a poison when ingested by molluscs and exposed to digestive enzymes. Preferably the aldehyde is a polar liquid with a Log P>2.2 and more preferably >2.5. Preferably the microbial cells are a yeast. Preferably the aldehyde content is between 20% and 60% (w/w) more preferably the aldehyde content is between 25% and 50% w/w).

TABLE 6
Metaldehyde equivalent dose rates for a typical 5 kg/ha spreading rate
of slug pellets

| | | | | | 50% encapsulated n-octana1/50% | | |
|---|---|---|---|---|---|---|---|
| | | 100% encapsulated 1-octanal | | | metaldehyde | | |
| | | equivalent to metaldehyde | | | | | Total |
| Metaldehyde | | (assuming activity reduction of 0.60) | | | | | 1-octanal |
| | Total | | | Total | Pellet % | | applied(g)/ |
| Pellet | applied | Pellet % | Pellet % | 1-octanal | 1-octanal/% | Pellet % | metaldehyde |
| % | (g) | 1-octanal | encapsulate | applied (g) | metaldehyde | encapsulate | applied (g) |
| 4% | 200 g | 6.7% | 23% | 333 g | 3.3%/2% | 11.5% | 166 g/100 g |
| 3% | 150 g | 5.0% | 17% | 167 g | 2.5%/1.5% | 8.6% | 83 g/75 g |
| 1.5% | 75 g | 2.5% | 8.65 | 125 g | 1.3%/0.75% | 4.4% | 63 g/38 g |

TABLE 7
Maximum kg/ha of slug pellets per calendar year
to stay within 700 g metaldehyde maximum per year

| | 4% | 3% | 1.5% |
|---|---|---|---|
| Metaldehyde | 17 | 23 | 46 |
| 50% encapsulated | 34 | 46 | 92 |
| 1-octanal/50% | | | |
| metaldehyde | | | |

| | |
|---|---|
| 100% encapsulated | Not covered by metaldehyde application restriction |
| 1-octanal | |

Table 6 shows how an effective dose equivalent for slug pellet formulations and their application rates can be calculated from relative potency and the aldehyde content of yeast encapsulate. Examples are given in the table for complete substitution of metaldehyde with encapsulated 1-octanal and for a 50% reduced metaldehyde formulation pellets.

### Example 3—Forced Ingestion Trials

Additional test material was prepared as described in Example 2 consisting of 29% 1-octanal (w/w) encapsulated in yeast and prepared as a fine dry flowing powder. This material was used to test for toxicity against the field slug Deroceras reticulatum, after involuntary, forced ingestion.

Adult slugs (250-350 mg) were collected from a field of mixed herbage and maintained in plastic boxes lined with moist absorbent paper. The slugs were starved for a period of 48 hours prior to forced ingestion.

Individual slugs were anaesthetised using CO₂ for a period of approximately 10 min. Test suspensions were made up to contain between 20 and 800 μg octanal as encapsulate per 20 μl. 20 μl aliquots of the test suspensions were then injected directly into the buccal cavities of the slugs using a micro syringe eased into the slug crop. The slugs were then placed into Petri dishes lined with moist, paper containing a small leaf disc (7 cm diameter), cut from lettuce (Lactuca sativa, var. “Iceberg”). The Petri dishes were maintained under controlled environmental conditions (12 hr photoperiod, 15° C., 90% RH), and feeding damage and slug health recorded daily over the subsequent five days.

TABLE 8
Effects of forced ingestion on microencapsulated octanal on
(mean of 10 replicate slugs in each treatment)

| Encapsulated | | | | | | | | |
|---|---|---|---|---|---|---|---|---|
| octanal (μg/slug) | Number of dead and moribund slugs | | | | | | | |
| Assessment day | 0 | 1 | 2 | 3 | 4 | 5 | 6 | 7 |
| 0 - Control | 0 | 0 | 0 | 0 | 0 | 0 | 0 | 0 |
| 40 | 0 | 0 | 2 | 4 | 5 | 5 | 5 | 5 |
| 60 | 0 | 0 | 2 | 4 | 5 | 7 | 8 | 8 |
| 80 | 0 | 2 | 4 | 6 | 7 | 7 | 7 | 7 |
| 120 | 0 | 0 | 0 | 0 | 3 | 8 | 9 | 9 |
| 400 | 0 | 2 | 2 | 4 | 7 | 9 | 9 | 9 |
| 800 | 0 | 8 | 8 | 10 | 10 | 10 | 10 | 10 |

TABLE 9
Effects of forced ingestion on microencapsulated octanal on feeding
behaviour (mean of 10 replicate slugs in each treatment)

| Encapsulated | | | | | | | |
|---|---|---|---|---|---|---|---|
| octanal (μg/slug) | Leaf discs consumed (%) | | | | | | |
| Assessment day | 1 | 2 | 3 | 4 | 5 | 6 | 7 |
| 0 - Control | 4.6 | 11.3 | 14.1 | 17.2 | 19.6 | 22.0 | 24.1 |
| 40 | 1.0 | 2.2 | 2.8 | 5.5 | 7.0 | 9.4 | 9.3 |
| 60 | 1.0 | 1.7 | 2.4 | 2.8 | 4.5 | 5.5 | 6.0 |
| 80 | 2.6 | 5.0 | 5.6 | 7.6 | 8.4 | 10.3 | 10.3 |
| 120 | 4.0 | 6.8 | 8.0 | 8.0 | 8.0 | 8.0 | 8.0 |
| 400 | 2.0 | 1.9 | 1.9 | 2.2 | 2.2 | 2.2 | 2.2 |
| 800 | 0 | 0.5 | 0.5 | 0.5 | 0.5 | 0.5 | 0.5 |

Tables 8 and 9 show the numbers of dead and moribund slugs resulting from forced ingestion and feeding inhibition over seven days. The results show high potency and effectiveness of the encapsulated octanal as a molluscicide following ingestion and a good progressive dose response in the range from 40 to 800 μg/slug of octanal and inhibition of feeding from day 1. The encapsulated octanol material was found to kill the slugs very effectively.

1. A molluscicidal dosage form comprising one or more microcapsule shells containing a fill; the shell comprising a water insoluble material which is digestible by a mollusc; and, the fill comprising an aldehyde of the formula R—CHO, wherein the R is a saturated C₃-C₁₂ alkyl.

2. The dosage form of claim 1, wherein the R is a linear C₃-C₁₂ alkyl.

3. The dosage form of claim 2, wherein the R is a linear C₇ to C₉ alkyl.

4. The dosage form of claim 3 wherein the aldehyde is selected from the group consisting of 1-heptanal, 1-octanal, 1-nonanal, and 1-decanal.

5. The dosage form of claim 4 wherein the aldehyde is selected from the group consisting of 1-heptanal, 1-octanal, and 1-nonanal.

6. The dosage form of claim 1, wherein the fill further comprises an excipient.

7. The dosage form of claim 6, wherein the excipient is an alcohol, carboxylic acid or an ester having a linear C7 to C9 alkyl group, R¹.

8. The dosage form of claim 7, wherein R¹ is R.

9. The dosage form of claim 1, wherein the shell is composed of a material selected from the group consisting of beeswax, starch, gelatine, polyacrylic acid, polyphosphate, alginate, chitosan, carrageenan, starch, modified starch, oligofructans, konjak, alpha-lactalbumin, beta-lactoglobumin, ovalbumin, poly(ethylene glycol) sorbitol hexaoleate, maltodextrin, cyclodextrin, cellulose, cellulose ether, methyl cellulose, ethyl cellulose, hydropropylmethylcellulose, carboxymethylcellulose, hydroxypropyl cellulose, milk protein, canola protein, albumin, chitin, polylactides, poly(lactide-co-glycolide) derivatized chitin oligosaccharides, polylysine, diutan gum, locust bean gum, welan gum and xanthan gum.

10. The dosage form of claim 1, wherein the size of the microcapsules is from 0.1 micron to 1000 microns.

11. The dosage form of claim 1, wherein the shell comprises a microbial cell body

12. The dosage form of claim 11, wherein the shell comprises a cell body derived from one or more fungi selected from the group consisting of Zygomycota, Glomeromycota, Ascomycota, Basidiomycota and Chytridiomycota.

13. The dosage form of claim 11, wherein the shell comprises a yeast cell body.

14. The dosage form of claim 11, wherein the fungi are selected from the group Saccharomycetes and Schizosaccharomycetes.

15. The dosage form of claim 14, wherein the fungi are selected from: Saccharomyces cerevisiae, Saccharomyces boulardii, Torula yeast (Candida utilis) and Schizosaccharomycetes pombe.

16. The dosage form of claim 1, including a coating applied to the one or more microcapsule shells.

17. The dosage form of claim 16, wherein the coating comprises a farinaceous material.

18. The dosage form of claim 17, wherein the coating comprises a material selected from the group consisting of starch, pectin, agar, gelatine, guar gum, gum arabinose, cellulose, polysaccharides and proteins.

19. The dosage form of claim 16, wherein the coating comprises a non-food carrier.

20. The dosage form of claim 18, wherein the starch is selected from arrowroot, corn starch, potato starch, sago, tapioca or modified and derivative starches.

21. The dosage form of claim 16, wherein the coating includes a vegetable gum selected from the group consisting of: guar gum, locust bean gum and xanthan gum.

22. The dosage form of claim 20, wherein the coating includes a protein selected from collagen, egg white, furcellaran and gelatine.

23. The dosage form of claim 16, wherein the coating includes a material to enhance palatability.

24. The dosage form of claim 16, wherein the coating includes a waterproofing agent.
